(19) United States
(12) Patent Application Publication
(10) Pub. No.: US 2022/0229868 A1
(43) Pub. Date: Jul. 21, 2022

(54) METHOD AND APPARATUS FOR AUTOMATED MAP OBJECT CONFLICT RESOLUTION VIA MAP EVENT NORMALIZATION AND AUGMENTATION

(71) Applicant: HERE Global B.V., Eindhoven (NL)

(72) Inventors: Hemanshu BELANI, Mumbai (IN); Aman JHA, Jamshedpur (IN); Ninad RAUT, Mumbai (IN)

(21) Appl. No.: 17/152,431

(22) Filed: Jan. 19, 2021

(51) Int. Cl. G06F 16/901; G06N 20/00

(52) U.S. Cl. CPC G06F 16/901; G06N 20/00

(57) ABSTRACT

An approach is provided for automated map object conflict resolution by time-collapsing and normalizing map events received within a time frame. The approach, for example, involves collecting a plurality of map events associated with a bounded geographic area within a designated number of time units from a point of time. The approach also involves initiating a time collapse of the plurality of map events to the point of time by setting timestamp data associated with the plurality of map events to the point of time. The approach further involves extracting one or more map features from the time-collapsed plurality of map events. The approach further involves providing the one or more map features as an output.

### BACKGROUND

Crowdsourcing takes inputs from diverse and unlimited number of sources. However, the inputs may come in various formats and/or quality, or sometimes conflicted. Taking map edits as an example, OpenStreetMap (OSM) is a collaborative mapping project established in 2004 to create a free editable map of the world. Although it is comprehensive and free, it contains errors, such as failing to indicate the presence of a map object that is present in the real world. Such errors can be later resolved by human volunteers. Certain map service providers involve human moderators to resolve crowdsourced map object conflicts which can take weeks. As a result, service providers and vehicle manufacturers face significant technical challenges to leverage crowdsourced event data (especially map edit data) and automate map object conflict resolution, in a way that can timely update digital map data.

### SOME EXAMPLE EMBODIMENTS

As a result, there is a need for automated map object conflict resolution by time-collapsing and normalizing map events received within a time frame.

According to one or more example embodiments, a computer-implemented method comprises collecting a plurality of map events associated with a bounded geographic area within a designated number of time units from a point of time. The method also comprises initiating a time collapse of the plurality of map events to the point of time by setting timestamp data associated with the plurality of map events to the point of time. The method further comprises extracting one or more map features from the time-collapsed plurality of map events. The method further comprises providing the one or more map features as an output.

According to another embodiment, an apparatus comprises at least one processor, and at least one memory including computer program code for one or more computer programs, the at least one memory and the computer program code configured to, with the at least one processor, cause, at least in part, the apparatus to collect a plurality of map events associated with a bounded geographic area within a designated number of time units from a point of time. The apparatus is also caused to initiate a time collapse of the plurality of map events to the point of time by setting timestamp data associated with the plurality of map events to the point of time. The apparatus is further caused to extract one or more map features from the time-collapsed plurality of map events. The apparatus is further caused to provide the one or more map features as an output.

According to another embodiment, a non-transitory computer-readable storage medium carries one or more sequences of one or more instructions which, when executed by one or more processors, cause, at least in part, an apparatus to collect a plurality of map events associated with a bounded geographic area within a designated number of time units from a point of time. The apparatus is also caused to initiate a time collapse of the plurality of map events to the point of time by setting timestamp data associated with the plurality of map events to the point of time. The apparatus is further caused to extract one or more map features from the time-collapsed plurality of map events. The apparatus is further caused to provide the one or more map features as an output.

According to another embodiment, an apparatus comprises means for collecting a plurality of map events associated with a bounded geographic area within a designated number of time units from a point of time. The apparatus also comprises means for initiating a time collapse of the plurality of map events to the point of time by setting timestamp data associated with the plurality of map events to the point of time. The apparatus further comprises means for extracting one or more map features from the time-collapsed plurality of map events. The apparatus further comprises means for providing the one or more map features as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of automated map object conflict resolution by time-collapsing and normalizing map events received within a time frame, according to one or more example embodiments;

FIG. 2A is a diagram illustrating example map event data sources, according to one or more example embodiments;

FIG. 2B is an example time sequence flattening and event aggregation process, according to one or more example embodiments;

FIG. 3 is a diagram of the components of a mapping platform, according to one or more example embodiments;

FIG. 4 is a flowchart of a process for automated map object conflict resolution by time-collapsing and normalizing map events received within a time frame, according to one or more example embodiments;

FIGS. 5A-5E are time-sequential diagrams of an example process for automated map object conflict resolution by time-collapsing and normalizing map events received within a time frame, according to one or more example embodiments;

FIG. 6 is a diagram of an example user interface capable of collecting map edits during navigation, according to one or more example embodiments;

FIG. 7 is a diagram of an example machine learning data matrix, according to one or more example embodiments;

FIG. 8 is a diagram of a geographic database, according to one or more example embodiments;

FIG. 9 is a diagram of hardware that can be used to implement an embodiment of the invention, according to one or more example embodiments.

FIG. 10 is a diagram of a chip set that can be used to implement an embodiment of the invention, according to one or more example embodiments.

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing output data for an end-to-end seamless experience during an autonomous vehicle trip are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

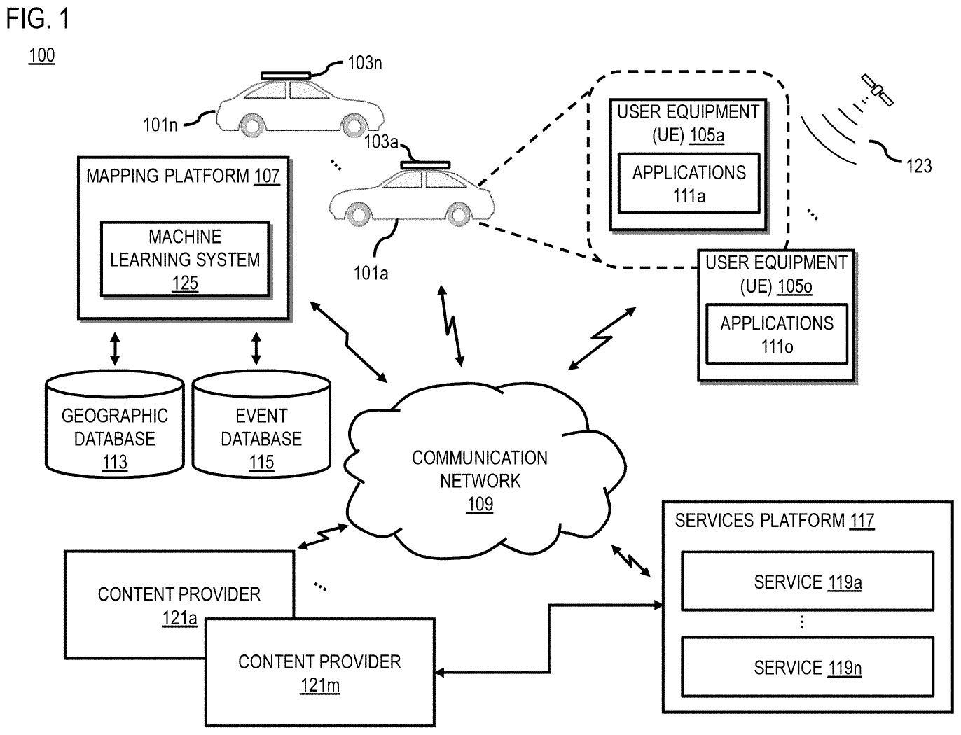

FIG. 1 is a diagram of a system 100 capable of automated map object conflict resolution by time-collapsing and normalizing map events received within a time frame, according to one or more example embodiments. Currently, most crowdsourced map updating systems are based on event-driven architectures that involve numerous sources and make communication among services and micro-services very complex. As there are tens of micro-services involved from map event insertion to ingestion, a receiving sequence of map events at an event-driven architecture cannot be guaranteed to be the same as the occurring sequence of the map events. In a typical crowdsourced environment, the event-driven architecture can collect random map edits from multiple sources; however, from time to time, the map edits that are received do not fit together for a given map tile (e.g., some map edits arrived out of sequence). For instance, a map edit of a point of interest (POI) related to a new road arrives at the event-driven architecture before a map edit of the new road. The event-driven architecture will fail to add such POI due to the non-existent road, which comes in later because of time lag. As another instance, the event-driven architecture will reject invalid map edit overlays, such as a road crossing a building (when actually the building no longer exists, while the road is valid). In another instance, the event-driven architecture will reject invalid outliers (e.g., troll map edit injections) which are simply incorrect yet received with valid map edits, such as adding a speed limit of 60 miles per hour (mph) on a narrow road. The narrow road addition is valid, but the high speed limit was injected to fail the valid map edit (e.g., the narrow road addition). This will cause the remaining contextual map edits following the narrow road addition also to fail. Sometimes the map edit rejections could be false negatives, i.e., incorrectly failing to indicate the presence of a map object/feature when it is present, and/or could lead to duplicate map edit events and/or map features.

As mentioned, such map object/feature conflicts or violations can be resolved by human moderators which can take from one week up to a few months. This approach involves human knowledge and cannot be scaled into an automated pipeline.

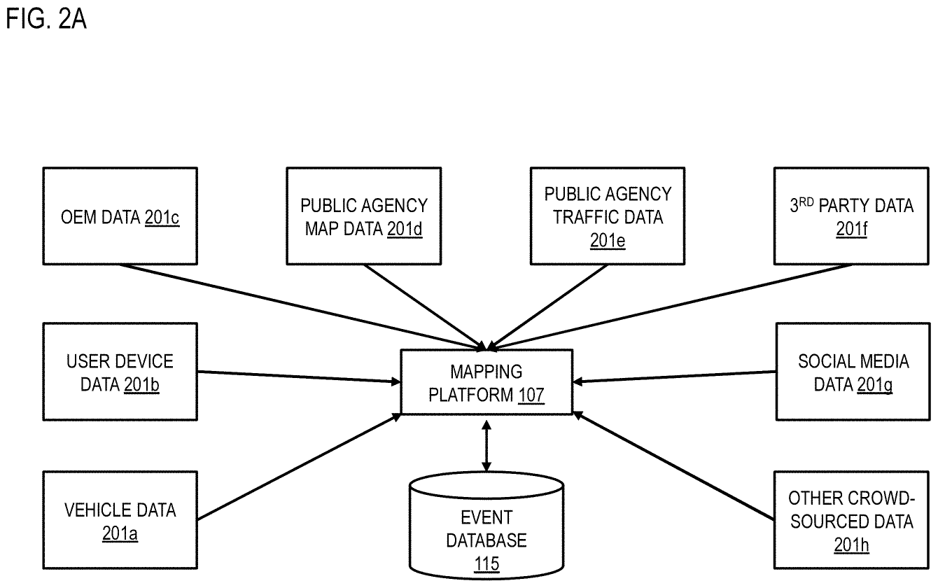

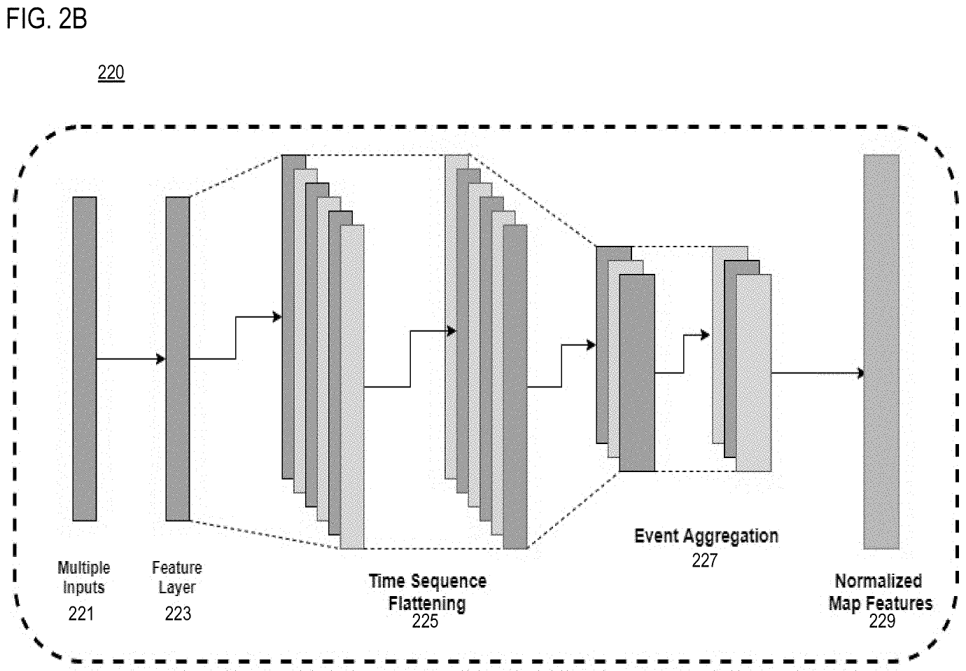

To address these challenges, the system 100 introduces a capability to automate map object conflict resolution by time-collapsing and normalizing map events received within a time frame. For example, the system 100 can collect data of map events from a plurality of different sources as shown in FIG. 2A with diverse reliability, quality, and information. FIG. 2A is a diagram illustrating example map event data sources, according to one or more example embodiments. For instance, the map event sources include vehicle data 201a, user device data 201b, original equipment manufacturer (OEM) data 201c, public agency map data 201d, public agency traffic data 201e, third party data 201f, social media data 201g, and other crowdsourced data 201h. For example, the vehicle data 201a may include map data and/or events collected by one or more vehicles 101a-101n (collectively referred to as vehicles 101) via its sensors 103a-103n (collectively referred to as sensors 103). For instance, the sensors 103 of the vehicles 101 can report sensor data (e.g., location data, Light Detection And Ranging (LiDAR) data, etc.) and/or probe data to a mapping platform 107 via a communication network 109.

The user device data 201b may include map data and/or events collected by one or more user equipment 105a-105o (collectively referred to UEs 105) via its sensors (not shown) and/or applications 111a-111o (collectively referred to applications 111). Some UEs 105 may be carried by users riding in a vehicle (e.g., the vehicles 101), while some UEs 105 may be carried by users doing other activities other than riding in a vehicle, such as walking, jogging, etc.

The OEM data 201c may include map data and/or events collected by one or more original equipment manufacturers of vehicles. The public agency map data 201d may include map data and/or events such as construction, zoning, address changes, etc. The public agency traffic data 201e may include map data and/or events such as road incidents, public transit, re-routing events, etc. The third party data 201f can include map data and/or events from companies and organizations across multiple industries which share map information (e.g., aerial photography), updates (e.g., Waze®, OSM, etc.), etc. The social media data 201g may include map data and/or events collected from social media feeds. The other crowd-sourced data 201h may include map data and/or events collected from other sources.

The mapping platform 107 can save the map events into a database (e.g., a geographic database 113 and/or a dedicated event database 115), and combine the map events for normalizing and augmentation, thereby increasing reliability of the ingested map objects/features. FIG. 2B is an example time sequence flattening and event aggregation process 220 according to one or more example embodiments.

The process 220 can include four steps: (1) Recording: collecting by a listener or listening for module geographic feature map events from different sources (e.g., the sources 201a-201h in FIG. 2A) as multiple inputs 221, and persisting the map events to a centralized event recorder as a feature layer 223; (2) Time Sequence Flattening and Event Aggregation: Collapsing a sequence of map events received during a time frame from t to t-n (i.e., time sequence flattening 225) and aggregating all the map events in the time frame as received at “t” (i.e., event aggregation 227) by a time sequence flattening and event aggregator; (3) Normalization: taking one snapshot of a sub-set of the map events per each time point, processing and normalizing the map events based on spatial geometry into normalized map features/events 229 by a normalizer; and (4) Resolving: taking the normalized map events for augmentation and conflict resolution. In one embodiment, the system 100 can develop a map events conflicts resolution (MECR) algorithm to provide accurate and reliable map edit/feature.

In short, the system 100 can solve the above-mentioned issues of receiving map edits out of sequence, etc., using time and space dimensions, by stretching time from {t} to {t-n}, getting the space information for each of the time slices, and rearranging the time slots to come up with the best fit map event sequence.

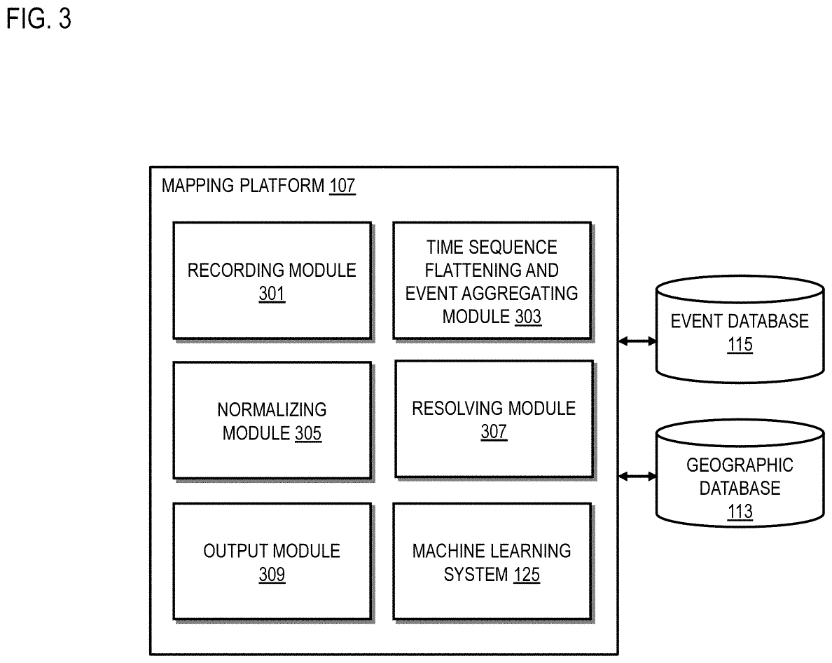

By way of example, the unit of re-arrangement can be a map tile defined with space geometry in three dimensions: latitude, longitude and elevation and bounded by a rectangle. The system 100 can apply an MECR algorithm as shown in Table 1 (to be explained later with respect to FIGS. 3-7).

```
TABLE 1
For each tile flagged with conflict
  Take a snapshot in time t
    Try sequencing and map normalizing and augmenting* the map edits
to get a valid tile
    If (valid tile)
      Pass it downstream for conflation
    Else (1*)
      Find all time-based snapshots for the tile, up to time t-n
      Combine map edits for all the time snapshots as if happening at
time t (time collapse)
      Try sequencing and map normalizing and augmenting* the map
edits to get a valid tile
      If(valid tile)
        Pass it downstream for conflation
      Else
        Iterate (1*) for t-n-n
        Recurse up-to max time rewind and collapse allowed.
```

In one embodiment, the mapping platform 107 can include a machine learning system 125 for analyzing normalized map event data and extracting valid map object/feature data. The extracted map object/feature data can be stored in the event database 115 and/or the geographic database 113.

In one embodiment, the mapping platform 107 can determine context data (e.g., a route, user-entered edits, vehicle sensed updates, driving environment, etc.) associated with normalized map events that have occurred or otherwise are associated with a map tile where the vehicles 101 and/or the UEs 105 were located during a latest time from a current time {t} to a time point {t-n}.

The mapping platform 107 can then resolve a map event conflict by a spatial heuristic and/or an artificial intelligence model developed by the machine learning system 125, considering context such as road link feature(s) (e.g., slope, curvature, functional classification, speed limit, signs (e.g., deer crossings), etc.), vehicle feature(s) (e.g., make, model, characteristics, capabilities-speed range, safety rating, working belts, working airbags, etc.), vehicle operation setting(s) (e.g., speed, autonomous vehicle (AV)/manual mode, etc.), user activity context (e.g., ages, weight, height, eyesight, pre-existing conditions, walking/running, etc.), environment context (e.g., visibility, weather, local events, traffic, traffic light status, construction status, etc.), etc.

In one embodiment, the mapping platform 107 can collect real-time sensor data, traffic incident information, and/or context data from the sources 201a-201h, sensors 103, one or more other sources such as government/municipality agencies, local or community agencies (e.g., a transportation department), and/or third-party official/semi-official sources (e.g., a services platform 117, one or more services 119a-119n (collectively referred to as services 119), and/or one or more content providers 121a-121m (collectively referred to as content providers 121), etc.

For instance, the context can include real time dynamic vehicle and traffic context extracted from sensor data (e.g., sensors 103, LiDAR and/or radar data from neighboring cars and/or connected services). The mapping platform 107 can resolve map event conflicts (e.g., a POI on a new road) by re-storing/shuffling a logical sequence of the map events, and validating a map object/feature (e.g., a road sign, a POI sign, etc.) based on their timestamp data and location data. As more autonomous vehicles 101 become more available with increasingly sophisticated sensors 103 and communication features and technologies that support more complicated map object/feature detection, the system 100 can better resolve map event conflicts.

After the conflict resolution, the mapping platform 107 can publish valid map object(s)/feature(s) to the vehicles 101 and/or the UEs 105 to support location-based services, such as navigation, autonomous driving, etc. By way of examples, the result can be used by an advanced driver-assistance system to set/adjust operational settings of the vehicles 101 to reduce a speed, change to a safer lane, braking, etc., so as to avoid traffic/blockage, shorten estimated time of arrival (ETA), mitigate potential accidents, etc.

As another example, the mapping platform 107 can transmit the valid map object(s)/feature(s) to update a digital map and/or a database (e.g., the geographic database 113) to support location-based services 119, such as vehicle navigation services, vehicle fleet management services, ride-sharing services, vehicle assistance/repair services, vehicle insurance companies, user health insurance companies, etc. to manage the vehicles 101, to adjust insurance rates, etc., depending on the valid map object(s)/feature(s).

In another embodiment, the mapping platform 107 can validate the map objects/features using cross-checking and/or feedback loops based on, for example, user/vehicle behavior(s) (e.g., from sensor 103 data) and/or feedback data (e.g., from survey data). For instance, a new road can be cross-checked by the artificial intelligence model that can detect from an aerial image that the new road is being built. As another instance, the new road can be cross-checked by probe data from sensors 103 of the vehicles 101 to see whether they are driving through the new road. As another instance, the mapping platform 107 can review open portal information from the relevant city to see whether the new road is part of the city plan, and/or check with postal office data to see if there are any new addresses/zip code(s) associated with the new road.

In summary, the system 100 can automatically process hundreds of millions of map edits in real-time or substantially real-time covering millions of kilometers (km) road length, millions of address changes, millions of place edits, etc. contributed by hundreds of millions of users worldwide, and resolve map feature conflicts and/or duplications in the map building process. The system 100 then can build and/or update an event database 115 that includes map events associated with a bounded geographic area, thus accelerating and improving the accuracy of digital map data which would otherwise require high manual efforts.

It is noted that although the various embodiments are discussed with respect to map events (e.g., map edits), it is contemplated that the embodiments are also applicable to general events occurred in a bounded geographic area that are received out of order/sequence in news feeds, video feeds, etc. In addition, it is further contemplated that the embodiments are applicable to map events associated with other modes of transport (e.g., buses, airplanes, subway trains, etc.), or non-vehicular modes of transport such as walking or other pedestrian means.

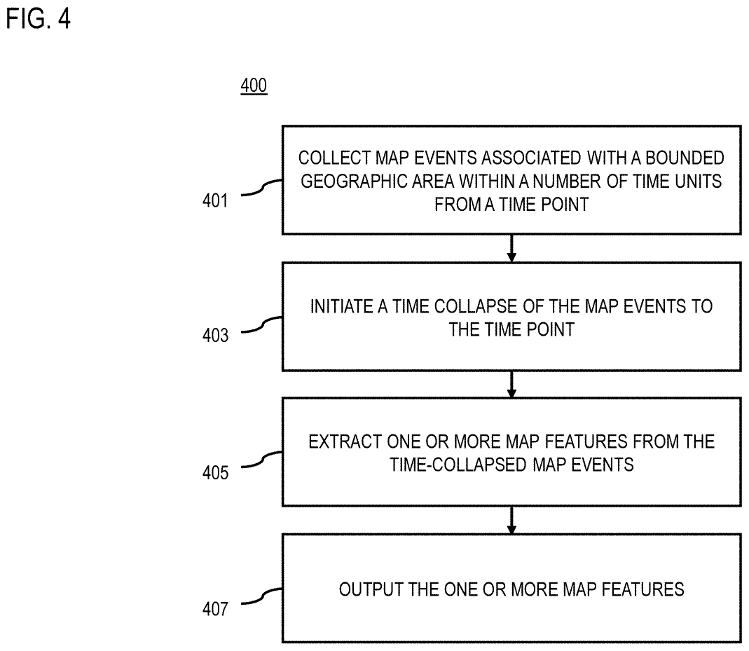

FIG. 3 is a diagram of the components of the mapping platform 107, according to one or more example embodiments. In one embodiment, the mapping platform 107 includes one or more components for automated map object conflict resolution by time-collapsing and normalizing map events received within a time frame according to the various embodiments described herein. As shown in FIG. 3, the mapping platform 107 includes a recording module 301, a time sequence flattening and event aggregating module 303, a normalizing module 305, a resolving module 307, an output module 309, and the machine learning system 125 and has connectivity to the event database 115 and/or the geographic database 113. The above presented modules and components of the mapping platform 107 can be implemented in hardware, firmware, software, or a combination thereof. The above presented modules and components of the mapping platform 107 can be implemented in hardware, firmware, software, or a combination thereof. It is contemplated that the functions of these components may be combined or performed by other components of equivalent functionality. Though depicted as a separate entity in FIG. 1, it is contemplated that the mapping platform 107 may be implemented as a module of any of the components of the system 100 (e.g., a component of the vehicles 101 and/or the UEs 105). In another embodiment, the mapping platform 107 and/or one or more of the modules 301-309 may be implemented as a cloud-based service, local service, native application, or combination thereof. The functions of the mapping platform 107, the machine learning system 125, and/or the modules 301-309 are discussed with respect to FIGS. 4-7 below.

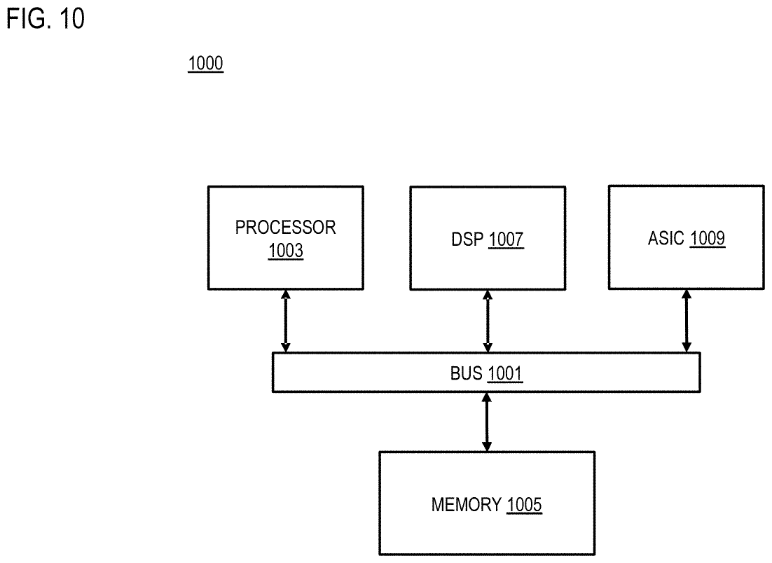

FIG. 4 is a flowchart of a process 400 for automated map object conflict resolution by time-collapsing and normalizing map events received within a time frame, according to one or more example embodiments. In various embodiments, the mapping platform 107, the machine learning system 125, and/or any of the modules 301-309 may perform one or more portions of the process 400 and may be implemented in, for instance, a chip set including a processor and a memory as shown in FIG. 10. As such, the mapping platform 107 and/or the modules 301-309 can provide means for accomplishing various parts of the process 400, as well as means for accomplishing embodiments of other processes described herein in conjunction with other components of the system 100. The steps of the process 400 can be performed by any feasible entity, such as the mapping platform 107, the modules 301-309, the machine learning system 125, etc. Although the process 400 is illustrated and described as a sequence of steps, it is contemplated that various embodiments of the process 400 may be performed in any order or combination and need not include all the illustrated steps.

In one embodiment, in step 401, the recording module 301 can collect a plurality of map events associated with a bounded geographic area within a designated number of time units from a point of time (e.g., a current time, any time point of interest, etc.). By way of examples, a time point of interest may be a time point of a car accident, a riot, an earthquake, etc.

For instance, the plurality or map events can be collected from a plurality of sources (e.g., the sources described in FIG. 2A). By way of example, the plurality of map events can include one or more map edits to digital map data associated with the bounded geographic area, and the point of time is a current time. The recording module 301 can receive a plurality of map edits from different sources at different time points in the space of time. For example, due to networking issues and/or delays, etc., the map edits may not come in the event occurring or generating order. To avoiding rejecting out-of-sequence map edits based on one or more map rules, the system 100 can perform the process 400. For example, a map rule used by the normalizing module 305 can be that a road exists before a road sign on the given road. As a result, a map edit of a road sign received by the recording module 301 before the arrival of a map edit of the road can be rejected based on the map rule.

In one embodiment, the recording module 301 can use a base layer and a delta layer (e.g., a staging layer to record the map edits which have not yet emerged into the digital map). The validation/conflict resolution by the normalizing module 305 then happens on the base layer via the new edits which have come in.

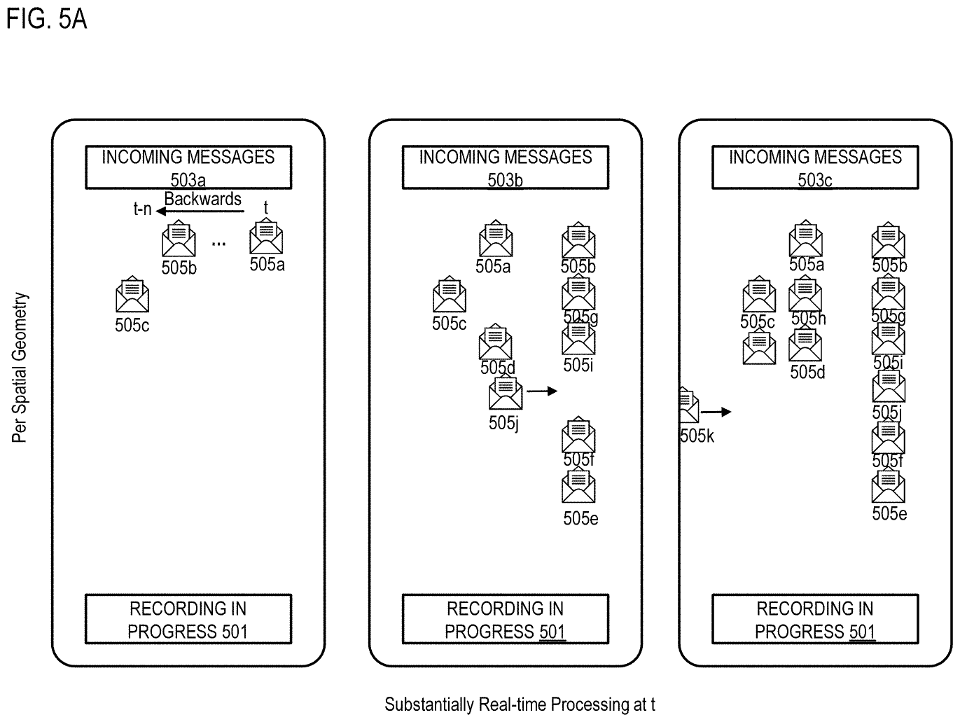

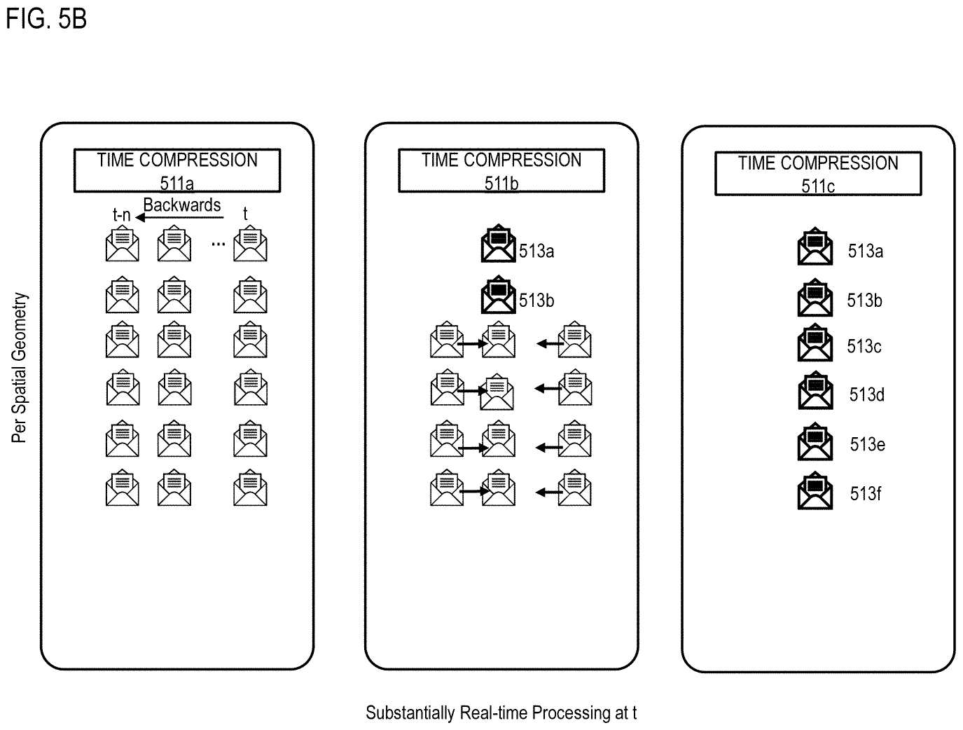

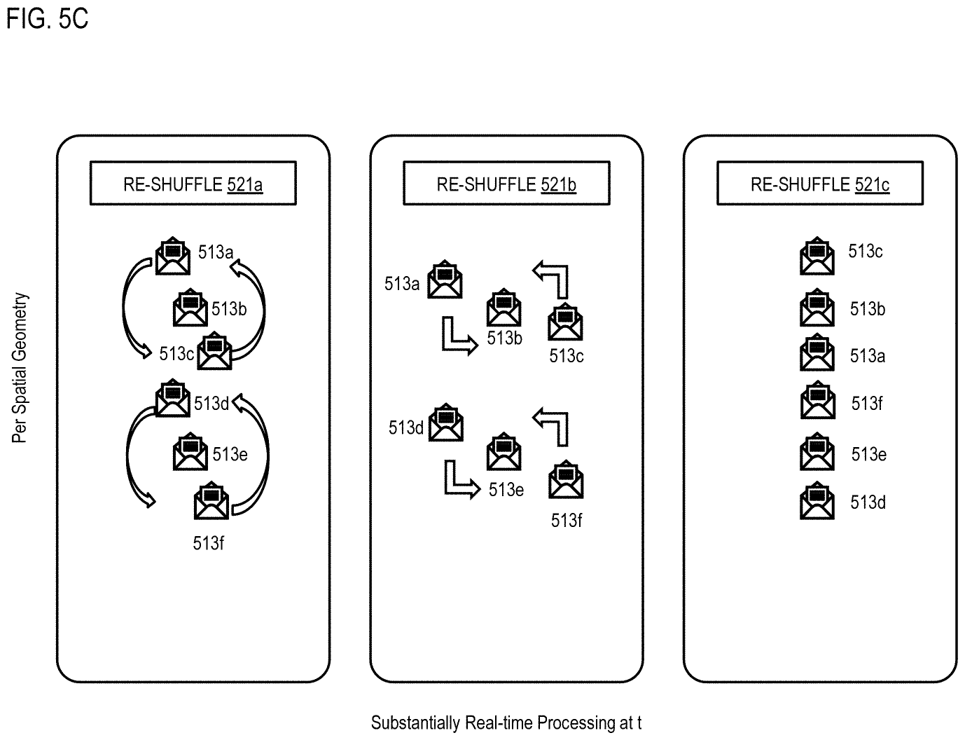

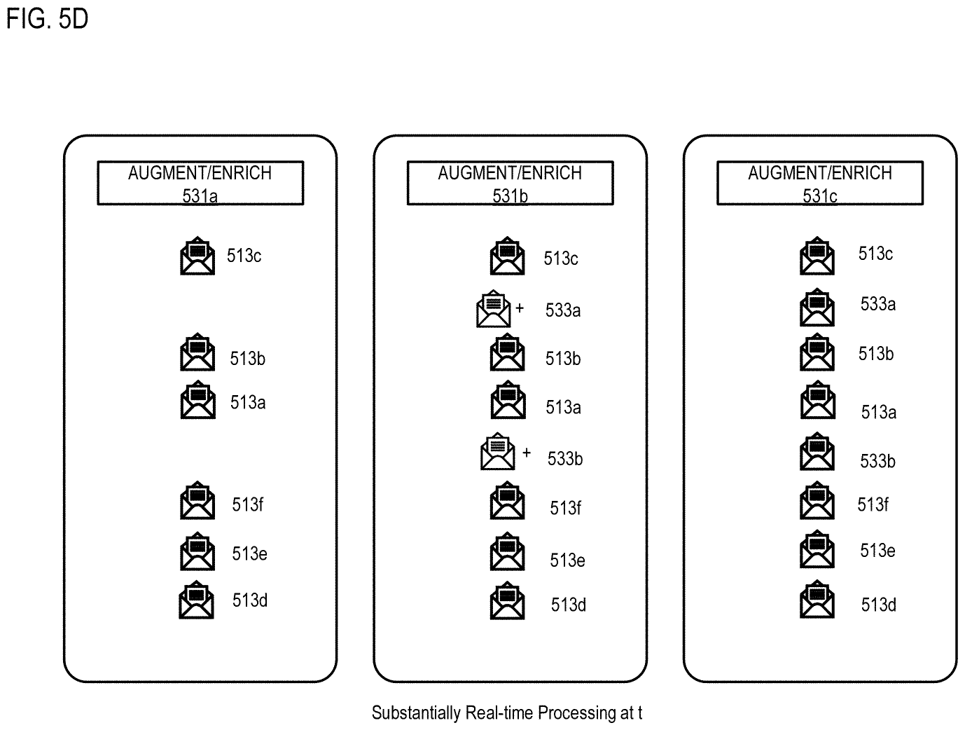

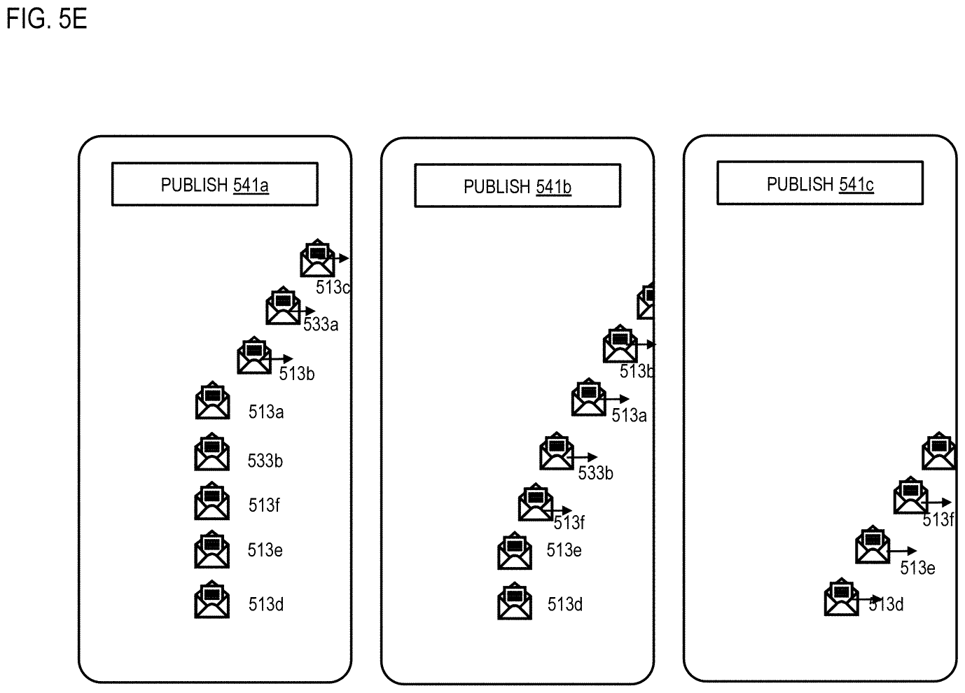

FIGS. 5A-5E are time-sequential diagrams of an example process for automated map object conflict resolution by time-collapsing and normalizing map events received within a time frame, according to one or more example embodiments. The map event data can be received via streams (e.g., Kafka, kinesis, spark streams etc.), queues, topic payloads, REST requests, etc.

Beginning with FIG. 5A, the recording module 301 can execute a recording process to listen for and record incoming map edit message. FIG. 5A shows a label 501 of “Recording in progress,” and a label indicating three “incoming messages” graphical representations of the process that occurs substantially in real-time or in real-time at {t} (e.g., a current time).

In an “incoming messages” graphical representation 503a, three event messages 505a-505c are received at or near {t-n}, i.e., a time point backwards n time unit from {t}, and recorded per spatial geometry (per map tile, per pixels in a map tile, per coordinates, etc.). For instance, the map edits can be aligned by map object/feature in each row, while by time unit per column. By way of example, an event message 505a received at {t} indicates a road sign on a new road, an event message 505b received at {t-3 } also indicates the road sign on the new road, while an event message 505c received at {t-n} indicates a point of interest sign on the new road.

Depending on the event context, the time unit can be a second, a minute, 2-minutes, 5-minutes, 10-minutes, etc., and the number “n” can be determined based on heuristics, such as a rule of thumb, an educated guess, etc. In one instance, the system 100 can deduce the optimal “n” to go back in time to assemble a map event sequence meeting one or more map rules to tell a logical story of the map events (i.e., the system 100 can absorb the map edits and can cluster in a logical time sequence or order).

In one embodiment, the number “n” is a function of the underlying map event creating and transmission system, such as a time taken at the sources (e.g., sources 201a-201h) to create the map edits, a time taken to transmit the map event data, a quality of the map edits received by the recording module 301, a resolution of the map edits (thus affecting processing time of the process 400), etc. With a very efficient underlying map event creating and transmission system, then the N would be a smaller value. In another embodiment, the heuristics and/or the function of the underlying map event creating and transmission system can be defined as a table/matrix base event context, such as a time taken at the sources to create the map edits, a time taken to transmit the map event data, a quality of the map edits to the recording module 301, a resolution of the map edits (thus affecting processing time of the process 400), etc.

In an “incoming messages” graphical representation 503b, additional event messages 505d-505j are received during the latest time frame {t-n} to {t}, and recorded per spatial geometry. In an “incoming messages” graphical representation 503c, one more event message 505k is being received during the latest time frame {t-n} to {t}, and recorded per spatial geometry. The recording processing continues until all map edits received from the sources (e.g., sources 201a-201h) during the latest time frame have been recorded.

In one embodiment, in step 403, the time sequence flattening and event aggregating module 303 can initiate a time collapse of the plurality of map events to the point of time by setting timestamp data associated with the plurality of map events to the point of time. The timestamp data can include the date and time when a map event is recorded. Referring back to Table 1, the bounded geographic area can be a map tile, and the time sequence flattening and event aggregating module 303 can determine the time frame of the time collapse as discussed.

FIG. 5B shows three graphical representations 511a-511c of a “time compress” step that occurs substantially in real-time or in real-time at {t} (e.g., a current time). For instance, the time sequence flattening and event aggregating module 303 can time collapse/compress some map edits 505 of an map object/feature in FIG. 5B per row into a time-collapsed map edit, to resolve conflicts and/or duplications. The time compression can occur concurrently, in a spatial order, randomly, etc. for the spatial rows. As mentioned, the rows can be ordered per spatial geometry (e.g., per map tile, per pixels in a map tile, per coordinates, etc.).

In a “time compress” graphical representation 511a, “n” columns of event messages 505 are recorded per different map object/feature in each row (e.g., six rows shown in FIG. 5B). Continuing with the new road example, the event message 505a received at {t} indicating a road sign on a new road, the event message 505b received at {t-3 } also indicating the road sign on the new road, and all other event messages received during {t-n} and {t} indicating the road sign on the new road are time collapsed/compressed into a time-collapsed map edit 513a for the road sign on the new road in a “time compress” graphical representation 511b. By analogy, the event message 505c received at {t-n} indicating the POI sign on the new road and all other event messages received during {t-n} and {t} indicating the POI sign on the new road are time collapsed/compressed into a time-collapsed map edit 513b for the POI sign on the new road in the “time compress” graphical representation 511b.

In a “time compress” graphical representation 511c, the remaining four map object/features in rows 3-6 are time collapsed/compressed time-collapsed map edits 513c-513f, respectively. By way of example, some map edits regarding the new road are time collapsed/compressed into a time-collapsed map edit 513c for the new road in the “time compress” graphical representation 511c.

In one embodiment, the normalizing module 305 can normalize the time-collapsed plurality of map events based on spatial geometry data, and the one or more map features can be extracted from the normalized plurality of map events. By way of example, some map edits regarding an event (e.g., an accident, a concert, a parade, etc.) on the new road are time collapsed/compressed into a time-collapsed map edit 513d for the event on the new road in the “time compress” graphical representation 511c. Since the time-collapsed map edit 513c for the new road is received before the time-collapsed map edit 513d for the event on the new road, it meets the map rule and will be passed downstream for conflation (e.g., based on the MECR algorithm as shown in Table 1).

In another embodiment, from the given point of time {t} to {t-n}, the system 100 can take snapshots, i.e., layers of a map of the bounded geographic area (e.g., a map tile) including one or more map objects/features and make a story in and of themselves to meet one or more map rules. For example, the road that is now there is a new road and there are certain signs or signboards already received, so time collapsing of the map layers can tell a story of a logical sequence of the map objects/features regardless of their receiving sequences. Based on determining that the first attempt of looking backwards to {t-n} has not resolved at least one conflict of the map events, the time sequence flattening and event aggregating module 303 can iterate an extension of the time frame to include additional time units {t-n-n} until the at least one conflict is resolved, a maximum time extension threshold is met, or a combination thereof.

Such maximum extending threshold constitutes the maximum time to be defined depending on available computational resources, and/or what it takes to tell a logical and/or clean story of conflicting map events. The system 100 can try by iterating to see if the logical and/or clean story is getting created. Maybe at the first iteration, the new road map edit has not come into the picture, but in the second iteration, the new road map edit may come into picture to complete a logical and/or clean story, e.g., using machine learning. In one embodiment, the “n” is a heuristic value, while the maximum extending threshold can be selected via machine learning.

For instance, the normalizing module 305 can sequence the time-collapsed plurality of map events based on a map building rule (e.g., a new road occurs before a road sign of the new road). By way of examples, the map building rule can be defined based on one or more spatial heuristics (e.g., a new road occurs before a road sign of the new road), one or more mathematical formulas, one or more spatial machine learning models, etc.

In one embodiment, in step 405, the resolving module 307 can extract one or more map features from the time-collapsed plurality of map events. For example, the one or more map features (e.g., a new road, a road sign on the new road, a POI sign on the new road, etc.) can be extracted from the time-collapsed plurality of map events.

FIG. 5C shows three graphical representations 521a-521c of a “reshuffle” step that occurs substantially in real-time or in real-time at {t} (e.g., a current time). For instance, the time sequence flattening and event aggregating module 303 can reshuffle the time-collapsed map edits 513a-513f of different map objects/features in the “reshuffle” graphical representation 521a based on a map rule, by swapping the time-collapsed map edits 513a, 513c and swapping the time-collapsed map edits 513d, 513f as transitioning into the “reshuffle” graphical representation 521b and finishing in the “reshuffle” graphical representation 521c. By way of example, swapping the time-collapsed map edit 513a for the road sign on the new road with the time-collapsed map edit 513c for the new road can correct the sequence and meet the map rule that a new road occurs before a road sign of the new road. As such, the sequence of a new road edit 513c→a POI sign of the new road 513c→a road sign on the new road 513a can be logically correct, after the time-collapsing, normalization, and reshuffling.

As another instance, the normalizing module 305 can repair the time-collapsed plurality of map events, the bounded geographic area, or a combination thereof based on a spatial heuristic (e.g., universal map building rules), a trained artificial intelligence model, mathematical formulas, or a combination thereof. For instance, the normalizing module 305 can remove one or more invalid map event overlays from the map events, remove one or more invalid outliers from the map events, etc. Examples of invalid map edit overlays include a road crossing a building when the building actually no longer exists, and the road is valid. By way of example, invalid outliers can be completely incorrect yet were received with valid map edits, such as troll map edit injections. Trojan horse attack on map edits can be carried out via adding a speed limit of 60 mph on a narrow road. The narrow road addition is valid, but the speed limit was injected to fail the map edit at the addition of the road. This will cause the rest of the contextual map edits following the road addition to also fail.

As yet another instance, the normalizing module 305 can augment the time-collapsed plurality of map events, the bounded geographic area, or a combination thereof based on a spatial heuristic, a trained artificial intelligence model, or a combination thereof. By way of example, FIG. 5D shows three graphical representations 531a-531c of an “augment/enrich” step that occurs substantially in real-time or in real-time at {t} (e.g., a current time). For instance, the normalizing module 305 can augment/enrich the time-collapsed map edits 513a-513f of different map objects/features in the “augment/enrich” graphical representation 531a, by augmenting/enriching map edits 533a and 533b (e.g., mobile work zones, etc.) as transitioning into the “augment/enrich” graphical representation 531b and finishing in the “augment/enrich” graphical representation 531c. Examples of mobile work zones include street cleaning trucks, tree trimming service cars, etc.

In one embodiment, in step 407, the output module 309 can provide the one or more map features (e.g., a new road, a road sign on the new road, a POI sign on the new road, etc.) as an output. Alternatively, the output module 309 can store the resulted map features data in digital map data, and provide the digital map data as an output. In another embodiment, the output module 309 can publish the output in a geographic database (e.g., the geographic database 113), a location-based service, or a combination thereof.

By way of example, FIG. 5E shows three graphical representations 541a-541c of a “publish” step that occurs substantially in real-time or in real-time at {t} (e.g., a current time). For instance, the output module 309 can sequentially publish the augmented/enriched map edits 513c, 533a, 513b, 513c, 533b, 513f, 513e, and 513d in a “publish” graphical representation 541a that transitions into a “publish” graphical representation 541b and finishes in a “publish” graphical representation 541c.

From the perspective of the vehicles 101, the system 100 can process user input data, sensor data, probe data, or a combination thereof associated with one or more devices located in a bounded geographic area (e.g., a map tile) within a designated number (e.g., “n”) of time units from a point of time (e.g., {t}) to determine a plurality of map events, initiate a time collapse of the plurality of map events to the point of time, extract one or more map features (e.g., a new road, a road sign on the new road, a POI sign on the new road, etc.) from the time-collapsed plurality of map events, and provide the one or more map features as an output. For instance, the one or more devices can be associated with one or more users (e.g., UEs 105), one or more vehicles (e.g., vehicles 101), or a combination thereof, and the one or more vehicles 101 can include one or more autonomous vehicles (AVs). By way of example, the devices that form an ad-hoc AV network can use V2V (vehicle-to-vehicle) communications to implement the embodiment.

In one embodiment, the system 100 can normalize the time-collapsed plurality of map events based on spatial geometry data, and the one or more map features can be extracted from the normalized plurality of map events.

In one embodiment, the system 100 can receive at least a portion of the user input data, the sensor data, the probe data, or a combination thereof via vehicle-to-everything (V2X) communications. By way of example, the V2X communications can incorporate more specific types of communication such as V2I (vehicle-to-infrastructure), V2N (vehicle-to-network), V2V, V2P (vehicle-to-pedestrian), V2D (vehicle-to-device), V2G (vehicle-to-grid), etc.

In another embodiment, the system 100 processes one or more events (e.g., traffic incidents) received via news/video feed data (e.g., via the content providers 121). For example, the news feeds can include traffic news feeds, a TV station news feeds, financial news feeds, social media news feed (e.g., status updates, photos, videos, links, app activity and likes from people, pages and groups that a user follows), etc. As another example, the video feeds can include traffic camera video feeds, etc.

The system 100 can collect a plurality of events associated with a bounded geographic area (e.g., a map tile) within a designated number (e.g., “n”) of time units from a point of time (e.g., {t}), initiate a time collapse of the plurality of events to the point of time by setting timestamp data associated with the plurality of events to the point of time, extract one or more map features (e.g., a new road, a road sign on the new road, a POI sign on the new road, etc.) from the time-collapsed plurality of events, and provide the one or more map features as an output. As other examples, the events can include one or more mobile work zones, one or more temporary traffic zones, or a combination thereof.

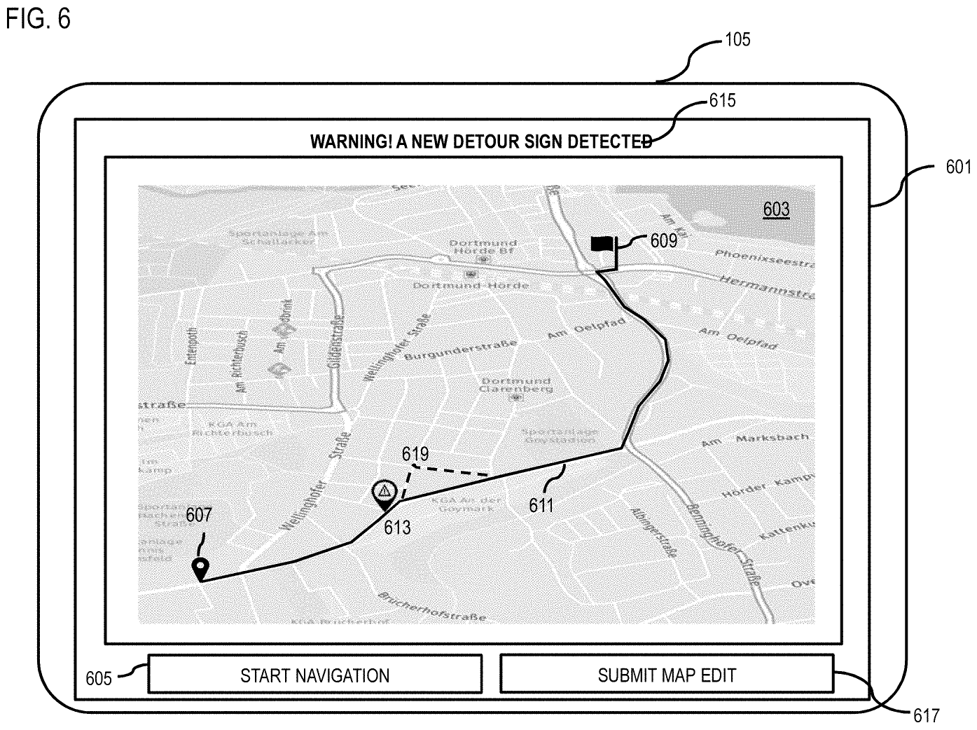

FIG. 6 is a diagram of an example user interface (UI) 601 (e.g., of a navigation application 111) capable of collecting map edits during navigation, according to one or more example embodiments. In this example, the UI 601 shown is generated for a UE 105 (e.g., a mobile device, an embedded navigation system, a client terminal, etc.) that includes a map 603, an input 605 of “Start Navigation” between an origin 607 and a destination 609 along a route 611. In this instance, in response to a user (e.g., a software programmer, a city planner, a driver) interacting with the input 605, the system 100 can detect a new map object/feature 613 (e.g., a new re-route sign) along the route 611 between the origin 607 and the destination 609 and can show an alert 615: “Warning! A New Detour Sign Detected.” In response to detection, the system 100 can generate the UE 105 such that it includes or presents an input 617 of “Submit Map Edit.” In one instance, in response to the user interacting with the input 617, the system 100 can generate the UI 501 such that it can automatically present a detour route 619 according to various embodiments described herein.

In one embodiment, the machine learning system 125 can build and train a map event machine learning model to resolve map edit conflicts based on inputs such as historical map conflict data, map event context, etc. For instance, the map event machine learning model can extract map event classification features and map the features to map event conflict categories such as out-of-sequence categories: e.g., road vs. road sign, invalid map edit overlays, etc., invalid outlier categories, etc. in a matrix/table).

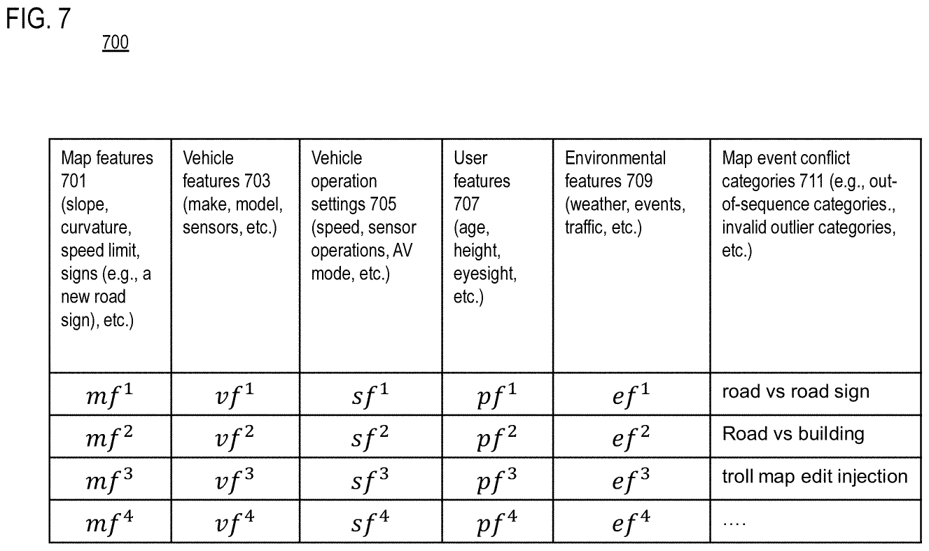

FIG. 7 is a diagram of an example machine learning data matrix 700, according to one or more example embodiments. In one embodiment, the matrix/table 700 can further include map feature(s) 701 (e.g., slope, curvature, speed limit, signs (e.g., a new road sign), etc.), vehicle feature(s) 703 (e.g., make, model, sensors, etc.), vehicle operation setting(s) 705 (e.g., speed, sensor operations, AV/manual mode, etc.), user features 707 (e.g., age, height, eyesight, etc.), environmental features 709 (e.g., visibility, weather, events, traffic, traffic light status, construction status, etc.), etc., in addition to the map event conflict categories 711 (e.g., out-of-sequence categories, invalid outlier categories, etc.). For instance, these classification features can be derived from map data, sensor data, context data of the vehicles 101, users, the environment, etc. in the context.

By way of example, the matrix/table 700 can list relationships among features and training data. For instance, notation [(mf)] Λi can indicate the ith set of map features, [(vf)] Λi can indicate the ith set of vehicle features, [(sf)] Λi can indicate the ith set of vehicle operation settings, [(pf)] Λi can indicate the ith set of user features,[(ef)] Λi can indicate the ith set of environmental features, etc.

In one embodiment, the training data can include ground truth data taken from historical map event data. For instance, in a data mining process, features are mapped to ground truth map objects/features to form a training instance. A plurality of training instances can form the training data for the map event machine learning model using one or more machine learning algorithms, such as random forest, decision trees, etc. For instance, the training data can be split into a training set and a test set, e.g., at a ratio of 60%:40%. After evaluating several machine learning models based on the training set and the test set, the machine learning model that produces the highest classification accuracy in training and testing can be used (e.g., by the machine learning system 125) as the map event machine learning model. In addition, feature selection techniques, such as chi-squared statistic, information gain, gini index, etc., can be used to determine the highest ranked features from the set based on the feature's contribution to classification effectiveness.

In other embodiments, ground truth map event data can be more specialized than what is prescribed in the matrix/table 700. For instance, the ground truth could be specific out-of-sequence map events. In the absence of one or more sets of the features 701-709, the model can still function using the available features.

In one embodiment, the map event machine learning model can learn from one or more feedback loops based on, for example, vehicle 101 behavior data and/or feedback data (e.g., from users), via analyzing and reflecting how map event conflicts were generated, etc. The map event machine learning model can learn the cause(s), for example, based on the map event categories and/or the map event conflict categories, to resolve the conflicts and add new objects/features into the model based on this learning.

In other embodiments, the machine learning system 125 can train the map event machine learning model to select or assign respective weights, correlations, relationships, etc. among the features 701-711, to resolve the conflicts and add new objects/features into the model.

In one instance, the machine learning system 125 can continuously provide and/or update the machine learning models (e.g., a support vector machine (SVM), neural network, decision tree, etc.) of the machine learning system 125 during training using, for instance, supervised deep convolution networks or equivalents. In other words, the machine learning system 125 trains the machine learning models using the respective weights of the features to most efficiently select optimal action(s) to take for different map event scenarios in different bounded geographic areas.

In another embodiment, the machine learning system 125 of the mapping platform 107 includes a neural network or other machine learning system(s) to update enhanced features in different bounded geographic areas. In one embodiment, the neural network of the machine learning system 125 is a traditional convolutional neural network which consists of multiple layers of collections of one or more neurons (which are configured to process a portion of an input data). In one embodiment, the machine learning system 125 also has connectivity or access over the communication network 109 to the event database 115 and/or the geographic database 113 that can each store map data, the feature data, the outcome data, etc.

The above-discussed embodiments can be applied to increase map accuracy and/or travel safety in any geographic areas.

In one instance, the UI 601 could also be a headset, goggle, or eyeglass device used separately or in connection with a UE 105 (e.g., a mobile device). In one embodiment, the system 100 can present or surface the output data in multiple interfaces simultaneously (e.g., presenting a 2D map, a 3D map, an augmented reality view, a virtual reality display, or a combination thereof). In one embodiment, the system 100 could also present the output data to a user through other media including but not limited to one or more sounds, haptic feedback, touch, or other sensory interfaces. For example, the system 100 could present the output data through the speakers of the vehicle 101.

In one embodiment, the system 100 can collect the sensor data, contextual data, or a combination through one or more sensors such as the vehicle sensor 103 (including camera sensors, light sensors, LiDAR sensors, radar, infrared sensors, thermal sensors, and the like), to determine the type/kind of the map events.

In one embodiment, the mapping platform 107 may provide interactive user interfaces (e.g., associated with the UEs 105) for collecting map edits. In addition, the output data can be interactive content that responds to user interactions through the user interface. For example, the user interface can present an interactive user interface element or a physical controller such as but not limited to a knob or roller ball-based interface, a pressure sensor on a screen or window whose intensity reflects the movement of time, an interface that enables gestures/touch interaction, an interface that enables voice commands, pedals or paddles of the autonomous vehicle (e.g., a vehicle 101), or a combination thereof. In one embodiment, the system 100 and the user interface element, e.g., a joystick, enables a user to provide map edits.

Returning to FIG. 1, in one embodiment, the vehicles 101 can be autonomous vehicles or highly assisted driving (HAD) vehicles that can sense their environments and navigate within a travel network without driver or occupant input. Although the vehicles 101 are depicted as automobiles, it is contemplated the vehicle 101 may be any type of transportation (e.g., an airplane, a drone, a train, a ferry, etc.). In one embodiment, the vehicle sensors 103 (e.g., camera sensors, light sensors, LiDAR sensors, radar, infrared sensors, thermal sensors, and the like) acquire map data and/or sensor data during operation of the vehicles 101 within the travel network for collecting map event data (e.g., map edits).

In one embodiment, the UEs 105 can be associated with any of the types of vehicles 101 or a person or thing traveling within the geographic area. By way of example, the UEs 105 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles or any combination thereof, including the accessories and peripherals of these devices, or any combination thereof. It is also contemplated that the UEs 105 can support any type of interface to the user (such as “wearable” circuitry, etc.). In one embodiment, the vehicles 101 may have cellular or wireless fidelity (Wi-Fi) connection either through the inbuilt communication equipment or from the UEs 105 associated with the vehicles 101. Also, the UEs 105 may be configured to access the communication network 109 by way of any known or still developing communication protocols.

In one embodiment, the UEs 105 include a user interface element configured to receive a user input (e.g., a knob, a joystick, a rollerball or trackball-based interface, a touch screen, etc.). In one embodiment, the user interface element could also include a pressure sensor on a screen or a window (e.g., a windshield of a vehicle 101, a heads-up display, etc.), an interface element that enables gestures/touch interaction by a user, an interface element that enables voice commands by a user, or a combination thereof. In one embodiment, the UEs 105 may be configured with various sensors for collecting user sensor data and/or context data during operation of the vehicle 101 along one or more roads within the travel network. By way of example, the sensors are any type of sensor that can detect a user's gaze, heartrate, sweat rate or perspiration level, eye movement, body movement, or combination thereof, in order to determine a user context or a response to output data.

In one embodiment, the mapping platform 107 has connectivity over the communication network 109 to the services platform 117 that provides the services 119. In another embodiment, the services platform 117 and the content providers 121 communicate directly. By way of example, the services 119 may also be other third-party services and include mapping services, navigation services, travel planning services, notification services, social networking services, content (e.g., audio, video, images, etc.) provisioning services, application services, storage services, contextual information determination services, location-based services, information-based services (e.g., weather, news, etc.), etc.

In one embodiment, the content providers 121 may provide content or data (e.g., including geographic data, output data, historical mobility data, etc.). The content provided may be any type of content, such as map content, output data, audio content, video content, image content, etc. In one embodiment, the content providers 121 may also store content associated with the event database 115, the geographic database 113, mapping platform 107, services platform 117, services 119, and/or vehicles 101. In another embodiment, the content providers 121 may manage access to a central repository of data, and offer a consistent, standard interface to data, such as a repository of the event database 115 and/or the geographic database 113.

By way of example, as previously stated the vehicle sensors 103 may be any type of sensor. In certain embodiments, the vehicle sensors 103 may include, for example, a global positioning sensor for gathering location data, a network detection sensor for detecting wireless signals or receivers for different short-range communications (e.g., Bluetooth, Wi-Fi, light fidelity (Li-Fi), near field communication (NFC) etc.), temporal information sensors, a camera/imaging sensor for gathering image data (e.g., for detecting objects proximate to the vehicles 101), an audio recorder for gathering audio data (e.g., detecting nearby humans or animals via acoustic signatures such as voices or animal noises), velocity sensors, and the like. In another embodiment, the vehicle sensors 103 may include sensors (e.g., mounted along a perimeter of the vehicles 101) to detect the relative distance of the vehicles 101 from any map objects/features, such as lanes or roadways, the presence of other vehicles, pedestrians, animals, traffic lights, road features (e.g., curves) and any other objects, or a combination thereof. In one scenario, the vehicle sensors 103 may detect weather data, traffic information, or a combination thereof. In one example embodiment, the vehicles 101 may include GPS receivers to obtain geographic coordinates from satellites 123 for determining current location and time. Further, the location can be determined by a triangulation system such as A-GPS, Cell of Origin, or other location extrapolation technologies when cellular or network signals are available. In another example embodiment, the one or more vehicle sensors 103 may provide in-vehicle navigation services.

The communication network 109 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, 2/3/4/5/6G networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the mapping platform 107 may be a platform with multiple interconnected components. By way of example, the mapping platform 107 may include multiple servers, intelligent networking devices, computing devices, components, and corresponding software for determining upcoming vehicle events for one or more locations based, at least in part, on signage information. In addition, it is noted that the mapping platform 107 may be a separate entity of the system 100, a part of the services platform 117, the one or more services 119, or the content providers 121.

By way of example, the vehicles 101, the UEs 105, the mapping platform 107, the services platform 117, and the content providers 121 communicate with each other and other components of the communication network 109 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

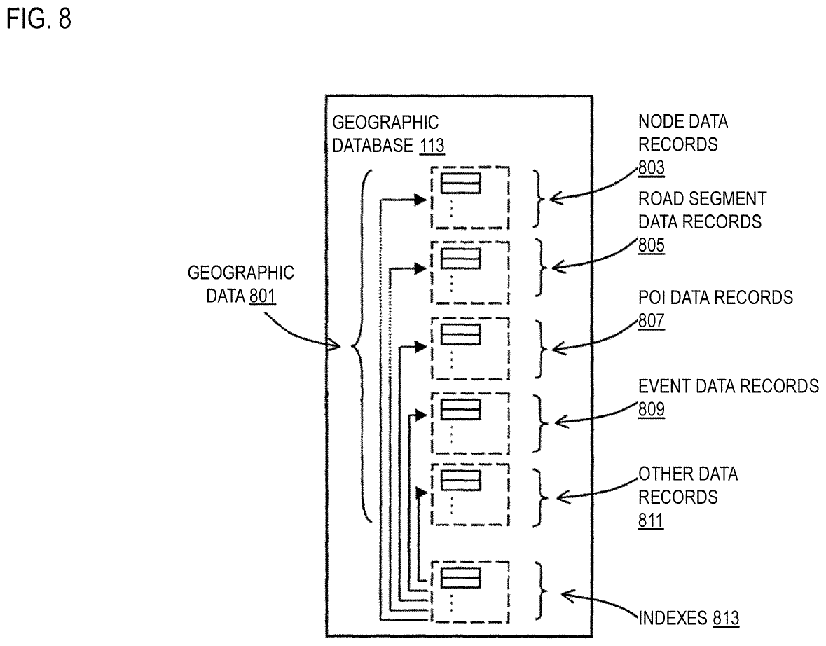

FIG. 8 is a diagram of a geographic database 113, according to one or more example embodiments. In one embodiment, the geographic database 113 includes geographic data 801 used for (or configured to be compiled to be used for) mapping and/or navigation-related services.

In one embodiment, geographic features (e.g., two-dimensional, or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the geographic database 113.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 113 follows certain conventions. For example, links do not cross themselves and do not cross each other except at a node. Also, there are no duplicated shape points, nodes, or links. Two links that connect each other have a common node. In the geographic database 113, overlapping geographic features are represented by overlapping polygons. When polygons overlap, the boundary of one polygon crosses the boundary of the other polygon. In the geographic database 113, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic data 801 of the geographic database 113 includes node data records 803, road segment or link data records 805, POI data records 807, event data records 809, other data records 811, and indexes 813, for example. More, fewer, or different data records can be provided. In one embodiment, additional data records (not shown) can include cartographic (“cartel”) data records, routing data, and maneuver data. In one embodiment, the indexes 813 may improve the speed of data retrieval operations in the geographic database 113. In one embodiment, the indexes 813 may be used to quickly locate data without having to search every row in the geographic database 113 every time it is accessed. For example, in one embodiment, the indexes 813 can be a spatial index of the polygon points associated with stored feature polygons.

In exemplary embodiments, the road segment data records 805 are links or segments representing roads, streets, or paths, as can be used in the calculated route or recorded route information for determination of one or more personalized routes. The node data records 803 are end points (such as intersections) corresponding to the respective links or segments of the road segment data records 805. The road link data records 805 and the node data records 803 represent a road network, such as used by vehicles, cars, and/or other entities. In addition, the geographic database 113 can contain path segment and node data records or other data that represent 3D paths around 3D map features (e.g., terrain features, buildings, other structures, etc.) that occur above street level, such as when routing or representing flightpaths of aerial vehicles 101 (e.g., drones), for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 113 can include data about the POIs and their respective locations in the POI data records 807. The geographic database 113 can also include data about places, such as cities, towns, or other communities, and other geographic features, such as bodies of water, mountain ranges, etc. Such place or feature data can be part of the POI data records 807 or can be associated with POIs or POI data records 807 (such as a data point used for displaying or representing a position of a city).

In one embodiment, the geographic database 113 can also include event data records 809 that can include map event data, map event category data, map event conflict category data, the resolved map event conflict data (e.g., valid map object/feature data), etc., for automated map object conflict resolution by time-collapsing and normalizing map events received within a time frame according to the embodiment described herein. In one embodiment, the event data records 809 can be associated with one or more of the node records 803, road segment records 805, and/or POI data records 807 so that the output data can inherit characteristics, properties, metadata, etc. of the associated records (e.g., location, address, POI type, etc.) of the corresponding destination or POI at selected destinations.

In one embodiment, the geographic database 113 can be maintained by the services platform 117 and/or any of the services 119 of the services platform 117 (e.g., a map developer). The map developer can collect geographic data to generate and enhance the geographic database 113. There can be different ways used by the map developer to collect data. These ways can include obtaining data from other sources, such as municipalities or respective geographic authorities. In addition, the map developer can employ aerial drones (e.g., using the embodiments of the privacy-routing process described herein) or field vehicles 101 (e.g., mapping drones or vehicles equipped with mapping sensor arrays, e.g., LiDAR) to travel along roads and/or within buildings/structures throughout the geographic region to observe features and/or record information about them, for example. Also, remote sensing, such as aerial or satellite photography or other sensor data, can be used.

The geographic database 113 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation capable device or vehicle. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for automated map object conflict resolution by time-collapsing and normalizing map events received within a time frame may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

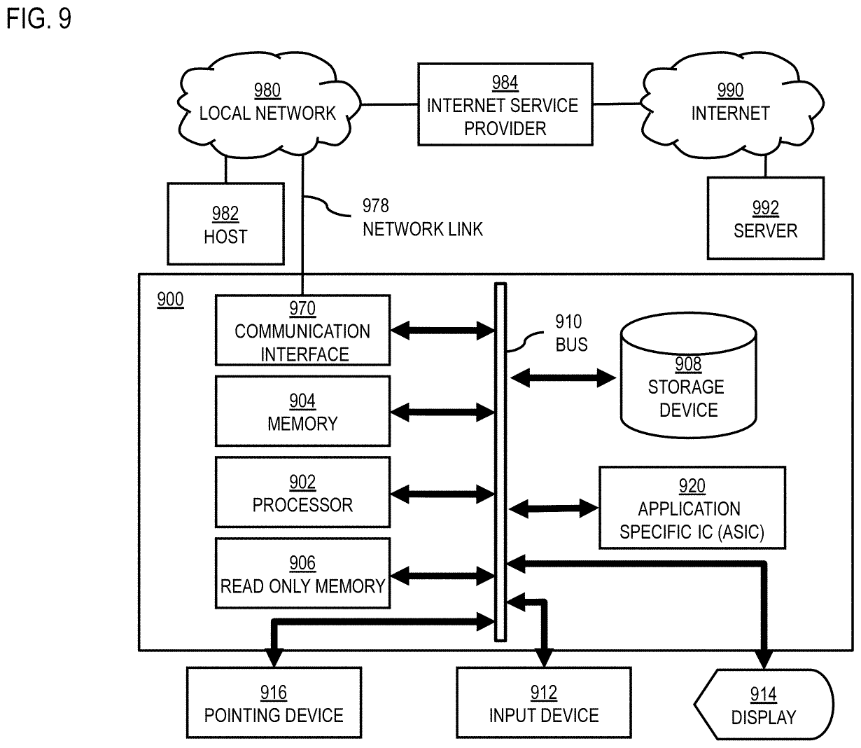

FIG. 9 illustrates a computer system 900 upon which an embodiment of the invention may be implemented. Computer system 900 is programmed (e.g., via computer program code or instructions) to automate map object conflict resolution by time-collapsing and normalizing map events received within a time frame as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to automated map object conflict resolution by time-collapsing and normalizing map events received within a time frame. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. The processors 902 may be implemented as mechanical, electrical, magnetic, optical, chemical or quantum components, among others, alone or in combination.

Computer system 900 also includes a memory 904 coupled to bus 910. The memory 904, such as a random access memory (RANI) or other dynamic storage device, stores information including processor instructions for automated map object conflict resolution by time-collapsing and normalizing map events received within a time frame. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk, or flash card, for storing information, including instructions, that persists even when the computer system 900 is turned off or otherwise loses power.

Information, including instructions for automated map object conflict resolution by time-collapsing and normalizing map events received within a time frame, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners, and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet.

Wireless links may also be implemented. For wireless links, the communications interface 970 sends or receives or both sends and receives electrical, acoustic, or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 109 for automated map object conflict resolution by time-collapsing and normalizing map events received within a time frame.

The term computer-readable medium is used herein to refer to any medium that participates in providing information to processor 902, including instructions for execution. Such a medium may take many forms, including, but not limited to, non-volatile media, volatile media, and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 10 illustrates a chip set 1000 upon which an embodiment of the invention may be implemented. Chip set 1000 is programmed to automate map object conflict resolution by time-collapsing and normalizing map events received within a time frame as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to automate map object conflict resolution by time-collapsing and normalizing map events received within a time frame. The memory 1005 also stores the data associated with or generated by the execution of the inventive steps.

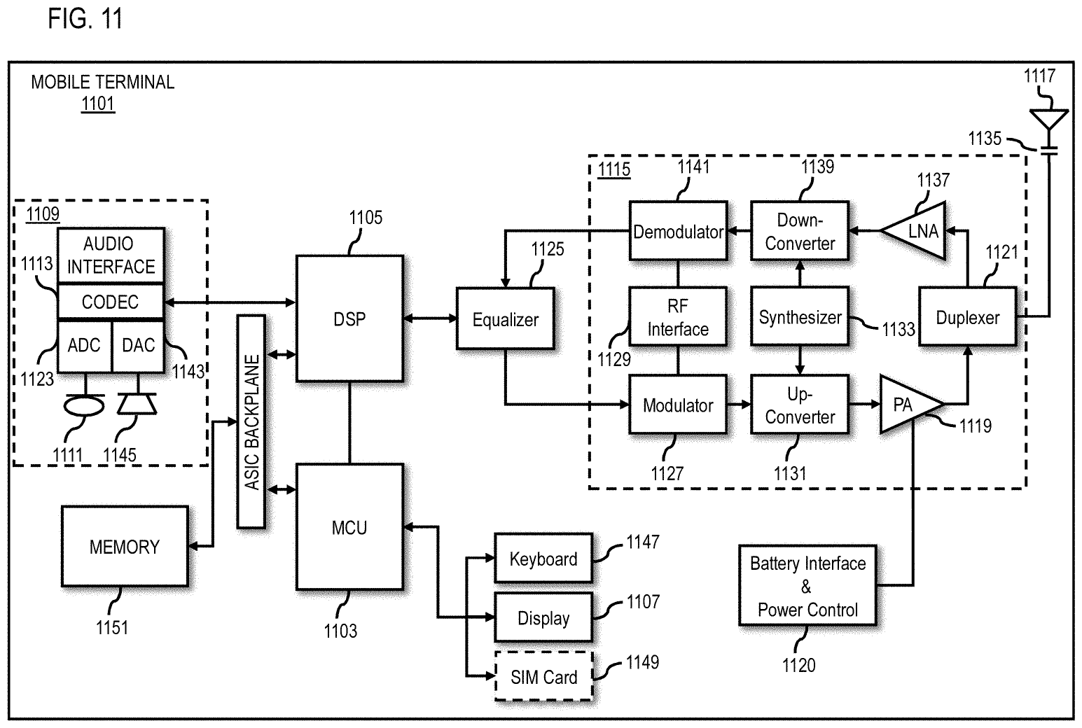

FIG. 11 is a diagram of exemplary components of a mobile terminal 1101 (e.g., such as a UE 105 or part thereof) capable of operating in the system of FIG. 1, according to one or more example embodiments. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that offer automatic contact matching. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to automate map object conflict resolution by time-collapsing and normalizing map events received within a time frame. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the mobile station 1101. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1151 may be, but not limited to, a single memory, CD, DVD, ROM, RAM, EEPROM, optical storage, or any other non-volatile or non-transitory storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
collecting a plurality of map events associated with a bounded geographic area within a designated number of time units from a point of time;
initiating a time collapse of the plurality of map events to the point of time by setting timestamp data associated with the plurality of map events to the point of time;
extracting one or more map features from the time-collapsed plurality of map events; and
providing the one or more map features as an output.

2. The method of claim 1, further comprising:
normalizing the time-collapsed plurality of map events based on spatial geometry data,
wherein the one or more map features are extracted from the normalized plurality of map events.

3. The method of claim 1, wherein the plurality or map events are collected from a plurality of sources.

4. The method of claim 1, wherein the plurality of map events include one or more map edits to digital map data associated with the bounded geographic area.

5. The method of claim 1, wherein the point of time is a current time.

6. The method of claim 1, further comprising:
sequencing the time-collapsed plurality of map events based on a map building rule.

7. The method of claim 1, further comprising:
repairing the time-collapsed plurality of map events, the bounded geographic area, or a combination thereof based on a spatial heuristic, a trained artificial intelligence model, or a combination thereof.

8. The method of claim 1, further comprising:
augmenting the time-collapsed plurality of map events, the bounded geographic area, or a combination thereof based on a spatial heuristic, a trained artificial intelligence model, or a combination thereof.

9. The method of claim 1, further comprising:
determining a time frame of the time collapse based on a time taken to create the map event data, a time taken to transmit the map event data, a quality of the map event data, a resolution of the map event data, or a combination thereof.

10. The method of claim 9, further comprising:
based on determining that at least one conflict of the map events has not been resolved, iterating an extension of the time frame to include additional time units until the at least one conflict is resolved, a maximum time extension threshold is met, or a combination thereof.

11. The method of claim 1, wherein the bounded geographic area is a map tile.

12. The method of claim 1, further comprising:
publishing the output in a geographic database, a location-based service, or a combination thereof.

13. An apparatus comprising:
at least one processor; and
at least one memory including computer program code for one or more programs, the at least one memory and the computer program code configured to, with the at least one processor, cause the apparatus to perform at least the following:
process user input data, sensor data, probe data, or a combination thereof associated with one or more devices located in a bounded geographic area within a designated number of time units from a point of time to determine a plurality of map events;
initiate a time collapse of the plurality of map events to the point of time;
extract one or more map features from the time-collapsed plurality of map events; and
provide the one or more map features as an output.

14. The apparatus of claim 13, wherein the one or more devices are associated with one or more users, one or more vehicles, or a combination thereof.

15. The apparatus of claim 13, wherein the one or more vehicles include one or more autonomous vehicles.

16. The apparatus of claim 13, wherein the apparatus is further caused to:
receive at least a portion of the user input data, the sensor data, the probe data, or a combination thereof via vehicle-to-everything communications.

17. The apparatus of claim 13, wherein the apparatus is further caused to:
normalize the time-collapsed plurality of map events based on spatial geometry data,
wherein the one or more map features are extracted from the normalized plurality of map events.

18. A non-transitory computer readable storage medium including one or more sequences of one or more instructions which, when executed by one or more processors, cause an apparatus to at least perform:
collecting a plurality of events associated with a bounded geographic area within a designated number of time units from a point of time;
initiating a time collapse of the plurality of events to the point of time by setting timestamp data associated with the plurality of events to the point of time;
extracting one or more map features from the time-collapsed plurality of events; and
providing the one or more map features as an output.

19. The non-transitory computer readable storage medium of claim 18, wherein the apparatus is caused to further perform:
receiving the plurality of events via one or more news feeds, one or more video feeds, or a combination thereof.

20. The non-transitory computer readable storage medium of claim 18, wherein the events include one or more traffic incidents, one or more mobile work zones, one or more temporary traffic zones, or a combination thereof.
